(19) United States
(12) Patent Application Publication
(10) Pub. No.: US 2006/0294012 A1
(43) Pub. Date: Dec. 28, 2006

(54) System and method for virtual attendance at special events

(76) Inventors: Steven J. Brattesani, San Francisco, CA (US); John Brattesani, San Francisco, CA (US); Jonathan Shiller, San Francisco, CA (US); Leon Gulchin, San Francisco, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/396,332

(22) Filed: Mar. 31, 2006

Related U.S. Application Data
(60) Provisional application No. 60/667,829, filed on Mar. 31, 2005.

(51) Int. Cl. G06Q 99/00

(52) U.S. Cl. 705/52

(57) ABSTRACT

A system and method that provides for “virtual attendance” in real-time, as well as provides for recording the event. The system generally includes at least one video camera, an interface with the Internet for transmission of real-time video, a server, and an optional recording device. The equipment is installed in the facilities of a non-profit or charitable organization by a service provider at no cost to the organization, and the service provider maintains and operates the system at no cost to the organization. The service provider then charges a fee to the person holding the event for use of the system. Revenues for providing the service are shared between the service provider and the organization providing the facilities for the event. Once the service provider recovers the cost of the equipment, the equipment is donated to the organization and, in addition, the organization receives a larger share of the revenues.

### CROSS-REFERENCE TO RELATED APPLICATIONS

This application claims priority from U.S. provisional application Ser. No. 60/667,829 filed on Mar. 31, 2005, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to providing remote access to special events, and more particularly to providing Internet access to special events held at the facilities of a non-profit or charitable organization and donating a portion of the revenues to the non-profit or charitable organization providing the facilities for the event.

2. Description of Related Art

Special events held at the facilities of non-profit and charitable organizations are ubiquitous. For example, churches hold weddings, funerals, memorials, baptisms, first communion, special masses, and other functions. However, there may be times when an invited guest is unable to attend the event. The typical solution is to record or videotape the event for later viewing. However, the cost of a doing so may be prohibitive for the person holding the event. Furthermore, a recording is viewed after-the-fact and does not have the impact of real-time viewing.

### BRIEF SUMMARY OF THE INVENTION

The present invention pertains to a system and method for providing remote access to special events via the Internet. One aspect of the invention is to provide remote access to a special event for a fee. In one embodiment, a service provider charges a fee for providing the remote access, and the fee is paid by the person or entity hosting the special event. Another aspect of the invention is to share a portion of the fee received by the service provider with a non-profit or charitable organization. In one embodiment, a portion of the fee received by the service provider is donated to the non-profit or charitable organization.

Accordingly, the present invention generally comprises a system and method that provides for “virtual attendance” at a special event. In one embodiment, remote attendance is in real-time. In one embodiment, the invention also provides for recording the event for viewing at a later time.

By way of example, and not of limitation, the system generally comprises at least one video camera, at least one microphone, an interface with the Internet for transmission of real-time video and audio, a server computer, and an optional recording device. The video camera(s), microphone(s), Internet interface, and optional recording equipment are installed in the facilities where the special event is to be held, and the server computer is installed in a remote location.

In one embodiment, the facilities at which the video camera(s), microphone(s), Internet interface, and optional recording equipment are installed are those of a non-profit or charitable organization, and the equipment is installed, maintained, and operated by a service provider at no cost to the organization. The service provider then charges a fee to the person or entity holding the event for use of the system. Revenues for providing the service are shared between the service provider and the organization providing the facilities for the event. In one embodiment, the non-profit or charitable organization charges a fee to the person or entity holding the event for use of the system, pays a portion of the fee to the service provider, and retains a portion of the fee as a charitable donation.

In one embodiment, once the service provider recovers the cost of the equipment installed at the facility, the equipment is donated to the organization. In one embodiment, once the service provider recovers the cost of the equipment installed at the facility, the organization receives a larger share of the revenues. In one embodiment, once the service provider recovers the cost of the equipment installed at the facility, the equipment is donated to the organization and the organization receives a larger share of the revenues.

The present invention is applicable to any type of special event, including, but not limited to, graduations, funerals, confirmations, baptisms, weddings, memorials, special masses, first communions, bah mitzvahs, and any other type of event typically held at the facilities of a church, synagogue, temple, mosque, or other non-profit or charitable organization. The system can be installed in any facility of a non-profit or charitable organization, including, but not limited to, places of worship, houses, auditoriums, halls, classrooms, gymnasiums and other facilities.

The system can also be installed in private facilities, including, but not limited to, auditoriums, hotels, resorts, offices, casinos, stores, and other facilities where special events can be held. Accordingly, various aspects of the invention are not limited to non-profit or charitable organizations. In one embodiment, the facilities at which the video camera(s), microphone(s), Internet interface, and optional recording equipment are installed are those of a private entity or organization, and the equipment is installed, maintained, and operated by a service provider at either no cost or for a fee to the entity or organization. In one embodiment, the service provider then charges a fee to the person or entity holding the event for use of the system. The facility provider may then charge the service provider a fee for providing the facilities for the event. In another embodiment, the facility provider may charge the person or entity holding the event a fee and pay over a portion of the fee to the service provider. Once the service provider recovers the cost of the equipment installed at the facility, the service provider can reduce its share of the fee for providing the service, or continue to receive the same share of the fee the entity with a corresponding increase in profit.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is schematic view of an embodiment of a video/audio broadcast system according to the invention.

FIG. 2 is a flowchart of an embodiment of a revenue generation and disbursement method according to the invention.

### DETAILED DESCRIPTION OF THE INVENTION

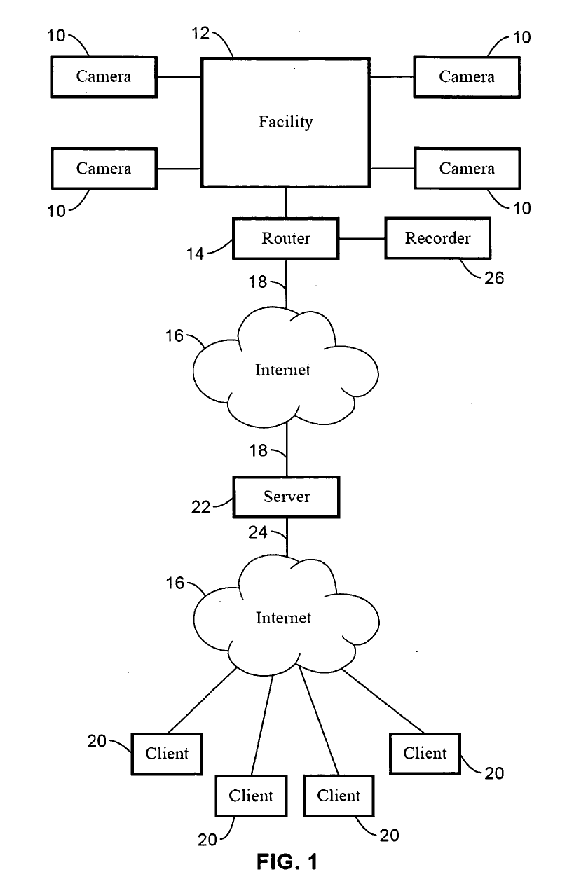

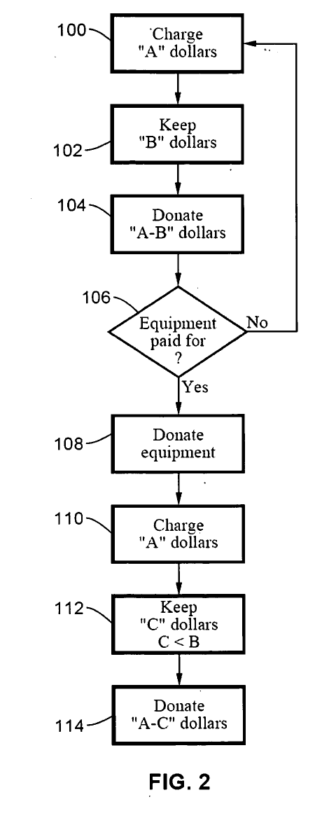

Referring more specifically to the drawings, the present invention is embodied in the system and method generally shown in FIG. 1 and FIG. 2. It will be appreciated that the system may vary as to configuration and as to details of the components, and that the method may vary as to the specific steps and sequence, without departing from the basic concepts as disclosed herein.

Referring first to FIG. 1, an exemplary embodiment of a system according to the present invention is illustrated. In the embodiment shown, one or more cameras 10 are installed in a facility 12 of a non-profit or charitable organization (also referred to herein as the “facility provider” ). The purpose of the cameras and microphones is to provide a video and audio feed (also referred to herein as a “media feed” ) to a remote user (also referred to herein as a “virtual guest”) who cannot attend an event. The service provider charges a fee to the person or organization holding the event (also referred to herein as the “event host” ) for use of the system to provide the media feed to the remotely located virtual guest.

Typically, the cameras would be placed at key vantage points that would provide various views of the area. For example, the cameras could be placed at high elevations at corners of the facility to look down on an area.

Another approach would be to place a camera in the back of the facility looking forward, another camera in the front of the facility looking backward, and another camera focused on a podium, altar, or other key location. It will be appreciated that the vantage points are a matter of choice to provide the desired coverage area, and that specific vantage points are not critical to practice of the present invention.

Many commercially available cameras also include microphones, in which case the audio would be picked up at the same locations. Alternatively, the microphones would be placed in appropriate locations for picking up sound associated with the video.

The cameras 10 are in turn connected to a router/modem 14 or the like that receives video feeds from the cameras and interfaces those video feeds with the Internet 16 through a broadband link 18. The audio feeds are received and transmitted in the same manner. The broadband link would typically be a lower cost DSL or cable broadband link, but higher cost, high speed links such as T1 or T3 links could be used as well. In one mode of operation, the router/modem would have an IP address that could be accessed over the Internet via one or more client devices 20. The client devices 18 could be computer workstations, personal digital assistants, cellular telephones, or any other device with Internet access.

It will be appreciated, however, that the bandwidth of the broadband link could be insufficient if a large number of client devices access the cameras at the same time. To address this situation, an alternative embodiment of the invention employs a server 22 between the video feed and the client devices. In this way, the server 20 can receive the video feed from the cameras using the bandwidth provided by a typical DSL or cable link. The server 22 would then be connected to a high bandwidth connection 24, such as a T1 or T3 connection to provide access by a large number of client devices. The audio feeds are then received and transmitted via server 22 in the same manner. It will be appreciated, therefore, that server 22 would be located offsite from the facility 12 such as in a data center, and could be controlled either locally or remotely.

In a further embodiment, a recording device 26 is provided for recording the video and audio feeds. Recording device 26 can be any conventional video recording device such as a VCR, DVD-R, and the like. The video feeds from the cameras 10 would be routed to the recording device 26 using conventional hardware which is well known to those skilled in the art. The audio feeds would be routed to the recording device 26 in the same manner.

In one embodiment of the invention, the cameras 10 are fixed position cameras. Accordingly, the video feed or recording would represent raw footage. In a further embodiment, the cameras 10 are equipped with motorized position controls so that they can be moved to obtain different views. Additionally, the cameras could have remote zoom capabilities. The technology for remotely controlling position and zoom of video cameras is known to those skilled in the art and will not be described in detail herein. Furthermore, those skilled in the art will appreciate that once these capabilities are provided, camera position and zoom can be controlled remotely by a client device. In this way, the views can be altered during the event to provide a customized broadcast or recording.

In the embodiment of the invention that uses a sever 22, which is the preferred embodiment, server 20 will provide user access to a website. At the website, the virtual guest will be provided with the capability of viewing the video feed from only one camera, from multiple cameras, enlarging the video feed from a particular camera, and other viewing options. For example, if there are four cameras providing video feeds, the virtual guest could choose to view all four on the display of the client device (e.g., side by side or in quadrants). The virtual guest can then select to view one of the video feeds full screen, or fewer than all four.

In a further embodiment of the invention, the video can be freeze-framed to provide video clips. The virtual guest can then store the video clips in memory on the client device, print the video clips as photographs, or store the video clips on the server.

Furthermore, the website can provide online ordering capabilities. For example, the virtual guest could choose to order a copy of a recording of the video feeds. Or, the virtual guest could make a donation to the facility provider. Furthermore, the website can provide a link to the facility provider's website.

Further enhancements can be provided to the user through the website as well. For example, the website can provide a map that can be clicked on by the virtual guest to locate events in a particular part of the country or locale. Alternatively, or in addition, the virtual guest could enter search information to locate an event. This will enable the virtual guest, who for some reason cannot remember exactly where the event is being held, to quickly and easily locate the event that they want to view. It will be appreciated that, for privacy reasons, the virtual guest would not be able to access every event but only that event to which the virtual guest was invited. Therefore, in one embodiment, the virtual guest will be required to enter a password to gain access to the video feed for the event. In one embodiment, the password would be mailed or e-mailed to a guest list by the event host. In another embodiment, the server would automatically e-mail the password to those on a guest list provided by the event host.

Additional e-commerce options that can be designed into the website include selling advertising on the user interface while the event is being broadcast. For example, a funeral home, wedding dress store, or other business could purchase banner space on the website which could include a link to the website of that business.

It will be appreciated by those skilled in the art that foregoing and other viewing and e-commerce options can be provided by the website using conventional web design and programming techniques.

With the foregoing in mind, it will be appreciated that the invention can provide a source of revenue to the service provider. In other words, the service provider would charge for the broadcast and recording of the event. This can be done by, for example, charging the event host a fee. Alternatively, the facility provider could be charged a fee by the service provider and in turn the facility provider could pass the fee through to the event host. In a further alternative, the facility provider would charge the event host a fee and pay over all or a portion of the fee to the service provider. However, in the preferred embodiment of the invention, the service provider charges the event host the fee rather than facility provider. Of course, there may be times when the facility provider is holding its own event, in which case they would be charged the fee by the service provider.

Referring to FIG. 2, an embodiment of a method of collecting and disbursing fees for the service is illustrated. In the embodiment shown, the service provider charges the event host a fee of “A” dollars at step 100 The service provider then retains “B” dollars to cover installation, maintenance and operation of the system at step 102, and donates “A minus B” dollars to the facility provider at step 104. Once the cost of the equipment is recovered at step 106, the service provider has the option of donating the equipment to the facility provider at step 108 and, in addition, has the further option of donating a higher share of the revenues to the facility provider as a result of the recovery of the cost of the equipment at steps 110 through 114. These options can be employed separately or in combination. For example, at step 110 the service provider charges the event host a fee of “A” dollars. The service provider than retains “C” dollars at step 112, wherein “C” is less than “B”. At step 114, the service provider then donates “A minus C” dollars to the facility provider. It will be appreciated that the foregoing methods provide revenue and tax benefits to the service provider and a source of charitable donations to the facility provider.

It will also be appreciated that the foregoing revenue collection and disbursement method can be modified for use with private entities or organizations or for other circumstances where tax benefits may not be available. For example, the service provider may elect to retain the entire fee charged to the event host. The facility provider may then charge the service provider a fee for providing the facilities for the event. Alternatively, the facility provider may charge the event host a fee and pay over a portion of the fee to the service provider. Once the service provider recovers the cost of the equipment installed at the facility, the service provider can reduce its share of the fee for providing the service, or continue to receive the same share of the fee the entity with a corresponding increase in profit.

In one embodiment of the invention, a website is provided through which an event host can arrange for use of the system at a facility provider where the service provider has already installed equipment for broadcasting live video and audio over the Internet. Through one or more web pages or screens, the event host would, for example, register the event, select a broadcast package from the service provider, and then invite guests to access or “attend” the event over the Internet. First, for example, the event host would begin the registration process by clicking or otherwise selecting a “getting started” or “registration” or other link. In response, the event host is presented with a web page that presents several types of events from which to select (e.g., baptism, wedding, graduation, memorial, communion, etc.). The event host would then select the type of event and an associated web page “template” or “wallpaper” which would appear on the screen of the invited guests.

A typical template or wallpaper would have graphics and text associated with a particular type of event, and, for example, would identify the date of the event, the time of the event, and the place of the event. Additionally, the template or wallpaper would have segments or windows in which the video feed(s) would be viewed, and, if multiple camera views are available or provided, will also present links for selection of different camera views by the invited guest.

After selecting a type of event and template, the event host is presented with a screen or web page to identify the event. Here, the event host would input, for example, the date of the event, time of the event, start and end time of the event, the location of the event (e.g., city and state), and whether the event is a public or private event.

Next, based on the state and city of the event, the event host is presented with a screen or web page where the event host can select from a list of participating facilities (e.g., a particular church) in that city and state where the event host will be holding the event.

Once the facility provider is selected, the event host is presented with a screen or web page from which the event host can select and purchase a package and options for the event. For example, the event host could select a basic package comprising the live video streaming and a free template. The event host could also select, and purchase, options such as multi-camera broadcast, an enhanced website for the event, invitation management, guest books, photo albums, and event recording and hosting.

Next, the event host is presented with a screen or webpage where the event host can provide detailed registration information concerning the event, such as name, e-mail address, password, mailing address, phone number, fax number, number of in-person guests expected, number of invited “virtual” guests expected, whether the event host wants to make a donation, and other general information.

Once the event host has registered and paid for the event, the event host is issued an “event code” to distribute to the guests that will allow them to login to the event if they cannot attend in person. In addition, the event host has the option of providing e-mail addresses of the guests, in which case the service provider distributes the event code automatically. At the date and time of the event, the guests can then go to the home page of the service provider's website and enter the event code to obtain access to the event as a “virtual guest”.

Those skilled in the art will appreciate that there are numerous ways in which a website can be constructed to implement all or a portion of the aspects of the present invention and the foregoing is provided by way of example only.

Although the description above contains many details, these should not be construed as limiting the scope of the invention but as merely providing illustrations of some of the presently preferred embodiments of this invention.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for providing donations to a non-profit or charitable organization, comprising:
installing a remote video feed system in a facility of the organization at no cost to the organization;
charging a fee to a person or entity holding an event in the facility for use of the remote video feed system;
retaining a portion of the fee; and
donating a portion of the fee to said organization.

2. A method as recited in claim 1, further comprising:
recovering equipment cost of said video feed system with said retained portion of said fee; and
donating said equipment to said organization after said equipment cost is recovered.

3. A method as recited in claim 2, further comprising increasing said donated portion of said fee after said equipment is donated to said organization.

4. A method as recited in claim 1, further comprising:
recovering equipment cost of said video feed system with said retained portion of said fee; and
increasing said donated portion of said fee after said equipment cost is recovered.

5. A method as recited in claim 1, wherein said video feed system comprises:
at least one video camera; and
an interface device connecting said video camera to an Internet connection.

6. A method as recited in claim 5, further comprising:
a remote located server connected an Internet connection;
said server accessible by at least one client device via an Internet connection;
wherein said server is accessible from a client device over a higher bandwidth connection than between said server and said interface device.

7. A method for providing donations to a non-profit or charitable organization, comprising:
installing a remote video feed system in a facility of the organization at no cost to the organization;
charging a fee to a person or entity holding an event in the facility for use of the remote video feed system;
retaining a portion of the fee;
donating a portion of the fee to said organization;
recovering equipment cost of said video feed system with said retained portion of said fee;
donating said equipment to said organization after said equipment cost is recovered; and
increasing said donated portion of said fee after said equipment is donated to said organization.

8. A method as recited in claim 7, wherein said video feed system comprises:
at least one video camera;
an interface device connecting said video camera to an Internet connection; and
a remote located server connected an Internet connection;
said server accessible by at least one client device via an Internet connection;
wherein said server is accessible from a client device over a higher bandwidth connection than between said server and said interface device.

9. A system for providing donations to a non-profit or charitable organization, comprising:
a remote video feed system installed in a facility of the organization;
a business system for generating and disbursing revenues from use of said video system, said business system comprising:
installing said remote video feed system at no cost to the organization;
charging a fee to a person or entity holding an event in the facility for use of the remote video feed system;
retaining a portion of the fee; and
donating a portion of the fee to said organization.

10. A system as recited in claim 9, wherein said business system further comprises:
recovering equipment cost of said video feed system with said retained portion of said fee; and
donating said equipment to said organization after said equipment cost is recovered.

11. A system as recited in claim 9, wherein said business system further comprises increasing said donated portion of said fee after said equipment is donated to said organization.

12. A system as recited in claim 8, wherein said business system further comprises:
recovering equipment cost of said video feed system with said retained portion of said fee; and
increasing said donated portion of said fee after said equipment cost is recovered.

13. A system as recited in claim 8, wherein said video feed system comprises:
at least one video camera; and
an interface device connecting said video camera to an Internet connection.

14. A system as recited in claim 12, further comprising:
a remote located server connected an Internet connection;
said server accessible by at least one client device via an Internet connection;
wherein said server is accessible from a client device over a higher bandwidth connection than between said server and said interface device.

15. A system for providing donations to a non-profit or charitable organization, comprising:
a remote video feed system installed in a facility of the organization;
a business system for generating and disbursing revenues from use of said video system, said business system comprising:
installing said remote video feed system at no cost to the organization;
charging a fee to a person or entity holding an event in the facility for use of the remote video feed system;
retaining a portion of the fee;
donating a portion of the fee to said organization;
recovering equipment cost of said video feed system with said retained portion of said fee;
donating said equipment to said organization after said equipment cost is recovered; and
increasing said donated portion of said fee after said equipment is donated to said organization.

16. A system as recited in claim 15, wherein said video feed system comprises:
at least one video camera;
an interface device connecting said video camera to an Internet connection; and
a remote located server connected an Internet connection;
said server accessible by at least one client device via an Internet connection;
wherein said server is accessible from a client device over a higher bandwidth connection than between said server and said interface device.
